(19) United States
(12) Patent Application Publication
(10) Pub. No.: US 2024/0426644 A1
(43) Pub. Date: Dec. 26, 2024

(54) FLOW RATE MEASUREMENT BY AMPLITUDE DIFFERENCE

(71) Applicant: SAGEMCOM ENERGY & TELECOM SAS, BOIS-COLOMBES (FR)

(72) Inventors: Abbas SABRAOUI, BOIS-COLOMBES (FR); Oussama ABID, BOIS-COLOMBES (FR); Ahmet Samed BASTURK, BOIS-COLOMBES (FR)

(21) Appl. No.: 18/749,946

(22) Filed: Jun. 21, 2024

(30) Foreign Application Priority Data
Jun. 23, 2023 (FR) FR2306602

(51) Int. Cl. G01F 1/667

(52) U.S. Cl. CPC G01F 1/667

(57) ABSTRACT

A measuring method, implemented in a meter (1) including a conduit (4) in which a fluid circulates, and an ultrasonic measuring device (6) including an upstream transducer (7a) and a downstream transducer (7b), the measuring method including the steps of applying an excitation electrical signal (Se) to the terminals of the upstream transducer, and acquiring a downstream electrical signal produced by the downstream transducer; applying the excitation electrical signal to the terminals of the downstream transducer, and acquiring an upstream electrical signal produced by the upstream transducer; and evaluating a flow rate of the fluid in the conduit, according to a first value representative of a difference between an amplitude of the upstream electrical signal and an amplitude of the downstream electrical signal.

The invention relates to the field of ultrasonic fluid meters.

### BACKGROUND OF THE INVENTION

An ultrasonic fluid meter typically comprises a conduit in which the fluid circulates and an ultrasonic measuring device comprising an upstream transducer (network side) and a downstream transducer (installation side of the subscriber). Each transducer successively plays the role as an emitter and a receiver of an ultrasonic signal. The upstream transducer thus emits an ultrasonic signal in the conduit, which is received by the downstream transducer after having travelled a predefined path in the fluid (of fully controlled length). Then, the downstream transducer itself emits an ultrasonic signal, which is received by the upstream transducer after having travelled the predefined path in the fluid (in the other direction). The ultrasonic measuring device thus evaluates the speed of the fluid from ultrasonic signal transit time, then the flow rate of the fluid from the speed of the fluid. The estimation of the flow rate of the fluid makes it possible to evaluate and to bill the quantity of fluid consumed.

The operating principle of the ultrasonic measuring device is therefore, based on measuring transit times of ultrasonic signals between the two transducers. The basic equations are as follows:

$$v = L / ( {t}_{-} AB - {t}_{-} BA ) , \qquad ( equation 1 )$$

where v is the speed of the fluid, L is the distance between the transducers, t_AB is the transit time between the upstream transducer and the downstream transducer, and t_BA is the transit time between the downstream transducer and the upstream transducer.

$$Q = A ⋆ v \qquad ( equation 2 )$$

where Q is the volumetric flow rate and A is the cross-section of the conduit.

Measuring transit time is typically done by using a “Zero Crossing” method, which requires detecting the alternations of the received signal.

This method can require taking measurements with a resolution/precision of around 1 picosecond. It is therefore, necessary to integrate an ASIC in the ultrasonic measuring device which increases the cost of it.

Moreover, measuring transit time is sensitive to the presence of bubbles or impurities in the fluid, which can create alternation jumps, thus falsifying the measurement of the flow rate.

An electrical signal produced by one of the transducers upon receiving an ultrasonic signal having travelled the predefined path is seen in FIG. 1.

The ultrasonic measuring device triggers the analysis of the ultrasonic signal (and in particular, the count of alternations) from the detection of the first alternation. If an alternation jump occurs, the analysis is triggered, for example, from the second alternation, which significantly degrades the precision of the measurement.

To resolve this problem, it is known to use filtering modules to filter the problematic measurements. These filtering modules are relatively complex to design and require a certain computing power. In addition, these filtering modules have a certain number of weaknesses. For example, it is possible that a user, occasionally, consumes a very high fluid flow rate, clearly greater than their usual consumption. The measurement of this flow rate thus risks being filtered and not considered by the meter; the flow rate peak is thus not billed.

### AIM OF THE INVENTION

The invention aims to reduce the cost of an ultrasonic fluid meter or to increase the precision of the measurements.

### SUMMARY OF THE INVENTION

In view of achieving this aim, a measuring method is proposed, implemented in a meter comprising a conduit, in which a fluid circulates and an ultrasonic measuring device comprising an upstream transducer and a downstream transducer, the measuring method comprising the steps of:
applying an excitation electrical signal at the terminals of the upstream transducer, so that it generates, in the conduit, an upstream ultrasonic signal, and acquiring a downstream electrical signal produced by the downstream transducer when it receives the upstream ultrasonic signal;
applying the excitation electrical signal to the terminals of the downstream transducer so that it generates, in the conduit, a downstream ultrasonic signal, and acquiring an upstream electrical signal produced by the upstream transducer when it receives the downstream ultrasonic signal;
evaluating a flow rate of the fluid in the conduit according to a first value, representative of a difference between an amplitude of the upstream electrical signal and an amplitude of the downstream electrical signal.

The measuring method therefore, evaluates the flow rate according to an amplitude difference between the upstream and downstream electrical signals. The amplitude difference is, for example, a voltage difference, which is relatively simple to measure and for which the required precision does not require using an ASIC (this measurement can, for example, be taken by a microcontroller). It is therefore, possible to reduce the cost of the ultrasonic measuring device and therefore, of the meter.

The flow rate can also be evaluated by using, in addition, a difference between the upstream and downstream transit times. In this case, the cost of the ultrasonic measuring device is not reduced, but the precision is greatly improved and the evaluation of the flow rate is consolidated by using the two quantities.

In addition, a measuring method such as described above is proposed, further comprising the steps of:
measuring an upstream transit time of the upstream ultrasonic signal between the upstream transducer and the downstream transducer;
measuring a downstream transit time of the downstream ultrasonic signal between the downstream transducer and the upstream transducer;
evaluating the flow rate of the fluid according to both the first value and a second value, representative of a difference between the upstream transit time and the downstream transit time.

In addition, a measuring method such as described above is proposed, in which the evaluation of the flow rate of the fluid is carried out, from the first value and from the second value, by using a multiple regression model.

In addition, a measuring method such as described above is proposed, comprising the steps of:
measuring the first value;
producing a first evaluation of the flow rate of the fluid by using the first value;
measuring the second value;
producing a second evaluation of the flow rate of the fluid by using the second value;
evaluating a third value, representative of a difference or of a ratio between the first evaluation and the second evaluation;
if the third value is greater than a predetermined threshold, not considering the first value and the second value;
if the third value is less than the predetermined threshold, producing a consolidated evaluation of the flow rate of the fluid according to the first value and the second value.

In addition, a measuring method such as described above is proposed, in which the third value is equal to: (Q2−Q1)/(Q2),
where Q1 is the first evaluation and Q2 is the second evaluation.

In addition, a fluid meter comprising a conduit in which the fluid circulates is proposed, an ultrasonic measuring device comprising an upstream transducer and a downstream transducer, and a processing unit, in which the measuring method such as described above is implemented.

In addition, a computer program is proposed comprising instructions which lead the processing unit of the meter as described above, to execute the steps of the measuring method such as described above.

In addition, a computer-readable recording medium is proposed, on which the computer program such as described above is recorded.

The invention will be best understood in the light of the description below of a particular, non-limiting embodiment of the invention.

### BRIEF DESCRIPTION OF THE DRAWINGS

Reference will be made to the accompanying drawings, among which:

FIG. 1 represents an electrical signal produced by a transducer when this captures an ultrasonic signal;

FIG. 2 represents an ultrasonic water meter;

FIG. 3 represents a graph comprising a curve of the amplitude difference between the upstream and downstream electrical signals, according to the flow rate;

FIG. 4 represents a graph comprising a curve of the upstream electrical signal, and a graph comprising a curve of the downstream electrical signal;

FIG. 5 represents a graph comprising a curve of the difference between the upstream and downstream transit times, according to the flow rate;

FIG. 6 represents the steps of the measuring method.

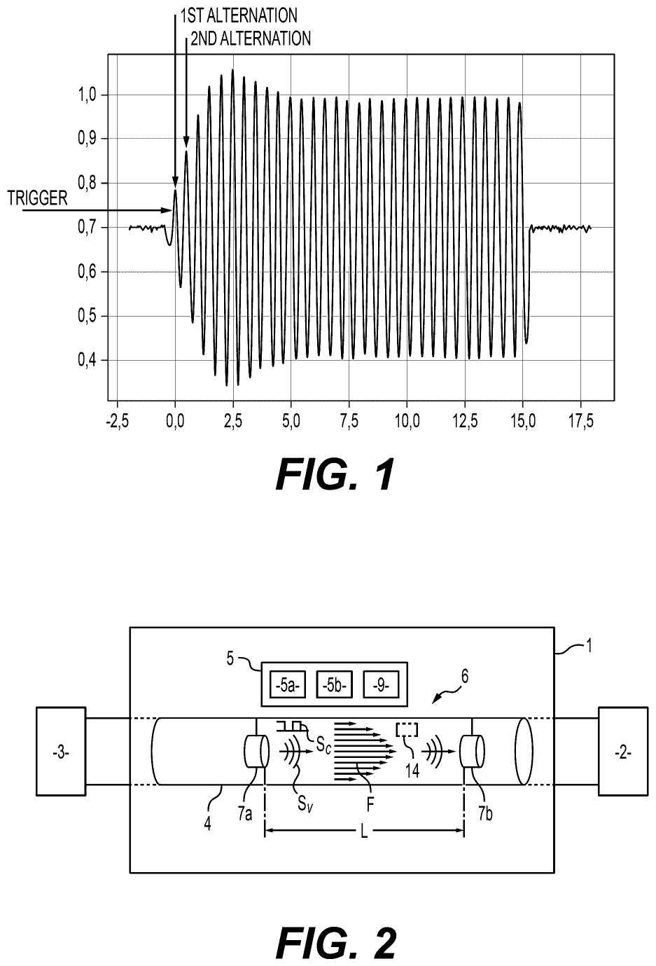

### DETAILED DESCRIPTION OF THE INVENTION

In reference to FIG. 2, the invention is implemented in an ultrasonic fluid meter 1. The meter 1 is, in this case, a water meter, which is used to measure the water consumption of the installation 2 of a subscriber. Water is supplied to the installation 2 by a water distribution network 3.

The meter 1 comprises a conduit 4, in which the water supplied by the network 3 to the installation 2, circulates. The water circulates in the conduit 4 from upstream to downstream, as is indicated by the direction of the arrows F. In this case, by “upstream”, this means the side of the network 3, and by “downstream”, this means the side of the installation 2.

The meter 1 comprises a processing unit 5 (electronic and software). The processing unit 5 comprises at least one processing component 5a, which is, for example, a “general” processor, a processor specialising in the processing of the signal (or DSP, for Digital Signal Processor), a microcontroller, or a programmable logic circuit, such as an FPGA (Field Programmable Gate Arrays) or an ASIC (Application Specific Integrated Circuit). The processing unit 5 also comprises one or more memories 5b, connected to or integrated in the processing component 5a. At least one of these memories 5b forms a computer-readable recording medium, on which is recorded, at least one computer program comprising instructions which lead the processing component 5a to execute at least some of the steps of the measuring method which will be described below.

The meter 1 also comprises an ultrasonic measuring device 6. The ultrasonic measuring device 6 is used to measure the flow rate of water supplied to the installation 2 by the network 3.

The ultrasonic measuring device 6 comprises an upstream transducer 7a and a downstream transducer 7b. The ultrasonic measuring device 6 also comprises a calculation module 9, integrated, in this case, in the processing unit 5, which performs the evaluations of the flow rate.

The upstream transducer 7a and the downstream transducer 7b are advantageously (but not necessarily) paired. The upstream transducer 7a and the downstream transducer 7b are, in this case, piezoelectric transducers.

Each transducer 7a, 7b successively plays the role of an ultrasonic signal transmitter and receiver.

The processing unit 5 generates an excitation electrical signal Se, and supplies the excitation electrical signal to the transmitter. The transmitter thus generates an ultrasonic signal Su. The receiver receives the ultrasonic signal after this has travelled a predefined path in the fluid.

The predefined path is, in this case, a direct path (parallel with respect to a longitudinal axis of the conduit 4, as is the case in FIG. 2, or inclined with respect to said axis). The predefined path could also be an indirect path: the ultrasonic signals are reflected against the internal wall of the conduit 4 (eventually against the reflectors themselves located on the internal wall).

The predefined path has a length L, which is known very specifically.

Thus, the processing unit 5 first applies the excitation electrical signal to the terminals of the upstream transducer 7a, so that it generates an upstream ultrasonic signal in the conduit 4. The processing unit 5 acquires a downstream electrical signal produced by the downstream transducer 7b when it receives the upstream ultrasonic signal.

Then, the processing unit 5 applies the excitation electrical signal to the terminals of the downstream transducer 7b so that it generates a downstream ultrasonic signal in the conduit 4. The processing unit 5 acquires an upstream electrical signal produced by the upstream transducer 7a when it receives the downstream ultrasonic signal.

The processing unit 5 analyses the downstream electrical signal and the upstream electrical signal to evaluate the flow rate of the water in the conduit 4.

A new way to evaluate the flow rate has been identified.

It has been observed, following numerous tests and numerous investigations and analyses, that the flow rate of the fluid can be evaluated from a value, representative of the difference between the amplitude of the upstream electrical signal and the amplitude of the downstream electrical signal.

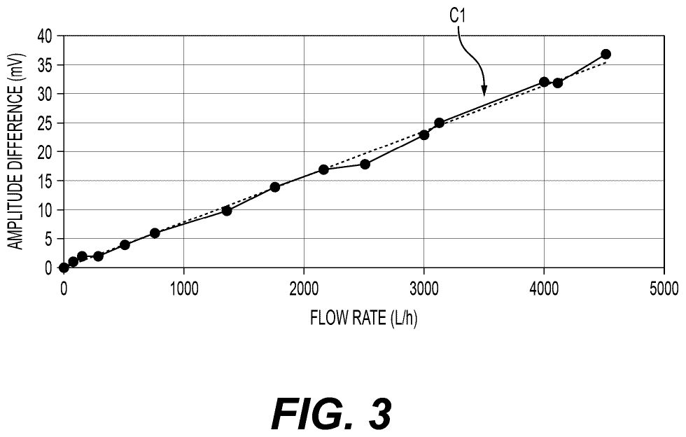

The correlation between the amplitude difference and the flow rate is seen in FIG. 3. The curve C1 has been obtained by a large number of measurements taken on a large number of meters.

When an alternation jump occurs, the amplitude difference does not follow this linear correlation, which indicates that the measurement is falsified.

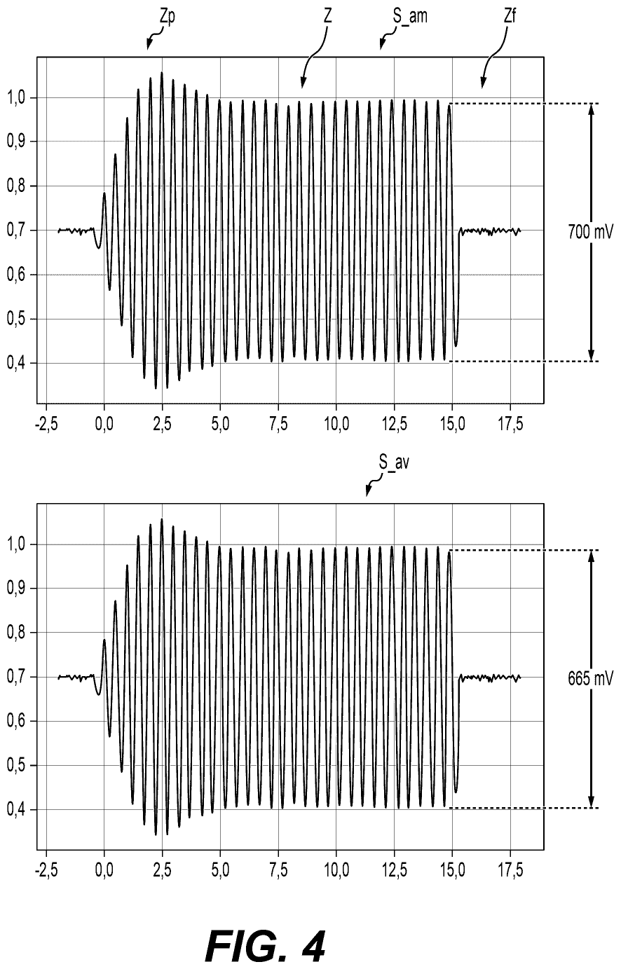

The upstream electrical signal S_am and the downstream electrical signal S_av are seen in FIG. 4.

In this case, by “amplitude” of the electrical signal (upstream or downstream), this means a value representative of a peak-to-peak amplitude of the electrical signal (upstream or downstream) when a variation of said peak-to-peak amplitude becomes less than a predefined variation threshold (which for example, equals to 5% or 10%).

This is, for example, an average value of the peak-to-peak amplitude in a predefined zone Z, located between a preliminary zone Zp and a final zone Zf of the electrical signal (upstream or downstream). In this case, the predefined zone comprises, for example, the lobes between the 12^{th} lobe and the 31^{st} lobe.

This could also be the peak-to-peak amplitude between a predetermined positive lobe and negative lobe, for example the 22^{nd} positive lobe and the next negative lobe.

This could also be an average of the maximum amplitudes of positive lobes in a predefined zone, or of the maximum amplitude of a predefined lobe, etc.

In FIG. 4, it is seen that the peak-to-peak amplitude in the predefined zone of the upstream electrical signal S_am is equal to 700 mV and that the peak-to-peak amplitude of the downstream electrical signal S_av is equal to 665 mV.

The origin of the amplitude difference of the upstream and downstream electrical signals to the flow can be attributed to dispersion, which is a phenomenon which causes the modification of the amplitude of the ultrasonic signals when they propagate through the fluid. Dispersion is influenced by the features of the fluid, such as viscosity, density and the presence of bubbles or impurities.

Thus, the measuring method consists of evaluating a flow rate of the fluid in the conduit 4 according to a first value representative of a difference between an amplitude of the upstream electrical signal S_am and an amplitude of the downstream electrical signal S av.

The following equation can be used:

$$Δ V = 0.0079 \times flow rate - 0.0477 , \qquad ( equation 1 )$$

where ΔV is a difference between the amplitude of the upstream electrical signal S_am and the amplitude of the downstream electrical signal S_av (the amplitude of each signal being the average of the peak-to-peak amplitude in the predefined zone).

The processing unit 5 therefore, evaluates the water flow rate in the conduit 4 according to a first value, representative of a difference between the amplitude of the upstream electrical signal and an amplitude of the downstream electrical signal.

In this case, to consolidate the measurement, the processing unit 5 also uses the transit times to evaluate the water flow rate.

The processing unit 5 analyses the downstream electrical signal S_av to measure the upstream transit time between the upstream transducer 7a and the downstream transducer 7b, and the upstream electrical signal S_am to measure the downstream transit time between the downstream transducer 7b and the upstream transducer 7a.

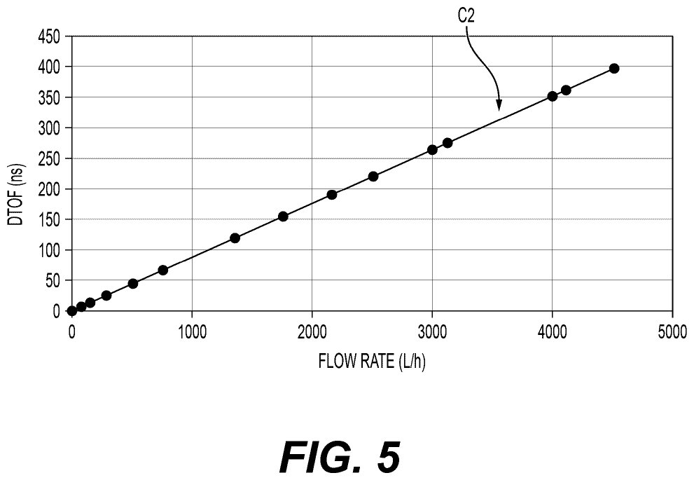

The curve C2 which represents the correlation between the flow rate and the difference between the transit times is seen in FIG. 5.

For example, the following equation can be used:

$$DTOF = 0.0876 \times flow rate + 0.686 , \qquad ( equation 2 )$$

where DTOF is the difference between the upstream transit time and the downstream transit time.

The processing unit 5 therefore, evaluates the water flow rate according to both the first value, representative of the difference between the amplitude of the upstream electrical signal and the amplitude of the downstream electrical signal, and of a second value, representative of the difference between the upstream transit time and the downstream transit time.

Therefore, there are two equations:

$$Δ V = 0.0079 \times flow rate - 0.0477 \qquad ( equation 1 )$$

$$DTOF = 0.0876 \times flow rate + 0.686 . \qquad ( equation 2 )$$

To improve the precision of the measurement, the processing unit 5 can combine the amplitude difference measurements with the transit time different measurements.

For this, a multiple regression model is used.

The multiple regression model is a statistical method used to analyse the relationships between several variables. In this case, there are two independent variables (ΔV and DTOF) and a dependent variable (flow rate). It is possible to use a multiple regression model to estimate the flow rate from ΔV and DTOF measurements.

In this case, a multiple linear regression model is used:

$$flow rate = a ⋆ ( DTOF - 0.686 ) + b ⋆ ( Δ v + 0.0477 )$$

In this example, “a” and “b” are the regression coefficients to be determined from the measurements taken. This multiple regression model combines the information of the two inverse equations to estimate the flow rate according to the ΔV and DTOF measurements simultaneously. Contrary to the univariate models, this model makes it possible to exploit the information supplied by the two independent variables to obtain a more precise and more reliable estimation of the flow rate.

To calibrate this model, a set of data is needed containing flow rate, ΔV and DTOF measurements. By using these data, it is possible to determine the coefficients “a” and “b” which minimise the sum of the quadratic errors between the flow rates observed and the flow rates predicted by the model.

Once the model is calibrated, it can be used to estimate the flow rate from new ΔV and DTOF measurements.

The coefficients “a” and “b” are determined in the factory by using data produced by a certain number of meters (for example 100 meters), which are representative of the meters which will be produced in mass production (same hydraulics, identical transducers, same geometry, etc.). The equation of the model is injected in the calculation module 9 of the processing unit 5, which will subsequently recover the DTOF and ΔV measurements, and will calculate the flow rate.

As an example, by using the two equations 1 and 2, the following is obtained:

$$flow rate = ( Δ v + 0.0477 ) / 0.0079 \qquad ( from equation 1 )$$

flow rate=(DTOF−0.686)/0.0876 (from equation 2)

These two expressions are equalised for the flow rate, and the following is obtained:

$$( DTOF - 0.686 ) / 0.08 \; 76 = ( Δ v + 0.0477 ) / 0.0079$$

This equation can be simplified to obtain:

$$DTOF \times 0.0079 - Δ V \times 0.0876 = 0.005246$$

By reorganising this equation, ultimately an expression is obtained for the flow rate according to ΔV and DTOF:

$$Flow = ( 0.0876 \times Δ V + 0.00 \; 79 \times DTOF - 0.005246 / 0.0803$$

Therefore, a third equation is obtained:

$$flow rate = \qquad ( equation 3 )$$

$$( 0.0876 \times Δ V + 0.0079 \times DTOF - 0.005246 ) / 0.0803 ,$$

$$and therefore , flow rate = 1.09 Δ V + 0.0 \; 980 DTOF - 0.0653 .$$

The processing unit 5 can therefore, produce a consolidated evaluation of the water flow rate according to the first value (difference between the amplitudes) and the second value (difference between the transit times).

The processing unit 5 can further determine if the measurement of the flow rate is correct or incorrect.

For this, the two equations are used which connect the flow rate to the DTOF and the flow rate to the ΔV:

$$flow rate = ( Δ V + 0.0477 ) / 0.0079 \qquad ( from equation 1 )$$

$$flow rate = ( DTOF - 0.686 ) / 0. 0 \; 876 \qquad ( from equation 2 )$$

Each time that the processing unit 5 measures a DTOF and a ΔV, the processing unit 5 will evaluate the two flow rates separately and, if a value representative of a difference or of a ratio between the two results is less than a predetermined threshold (for example equal to 5%), the processing unit 5 considers that the evaluations are valid and produces a consolidated evaluation by using the equation 3.

However, if the value representative of a difference or of a ratio between the two results is greater than this predetermined threshold, the measurement will be considered as incorrect and will therefore, be refused by the processing unit 5. The processing unit 5 will replace the incorrect measurement with the last valid measurement and will raise an alarm to signal the refused measurement by indicating the difference observed between the two flow rates from the two equations.

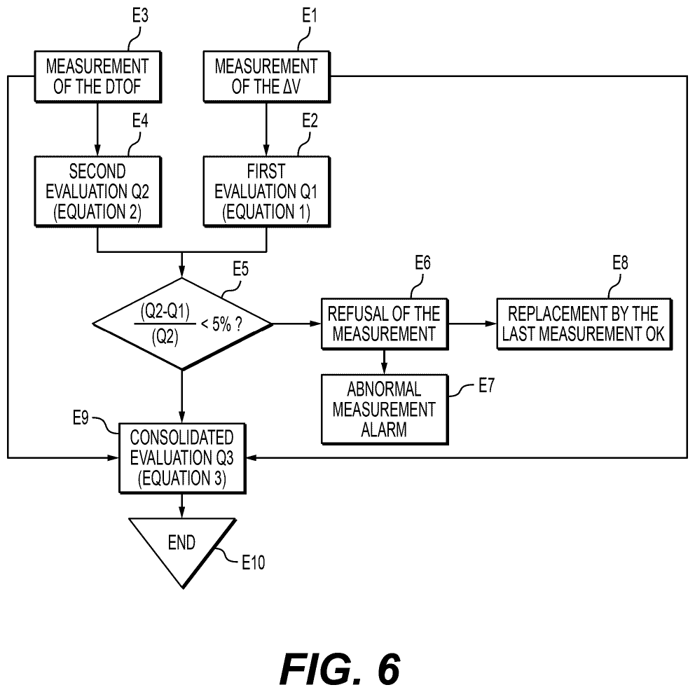

Now, the measuring method is described in reference to FIG. 6.

The processing unit 5 measures a first value representative of a difference between an amplitude of the upstream electrical signal and an amplitude of the downstream electrical signal: step E1. The first value is, in this case, equal to this difference ΔV.

Then, the processing unit 5 produces a first evaluation Q1 of the water flow rate by using the first value ΔV: step E2.

The processing unit 5 measures a second value, representative of a difference between the upstream transit time and the downstream transit time: step E3. The second value is, in this case, equal to this DTOF difference.

Then, the processing unit 5 produces a second evaluation Q2 of the water flow rate by using the second value: step E4.

The processing unit 5 evaluates a third value, representative of a difference or of a ratio between the first evaluation and the second evaluation: step E5.

In this case, this third value is equal to:

$$( Q 2 - Q 1 ) / ( Q 2 ) ,$$

Where Q1 is the first evaluation of the water flow rate and Q2 is the second evaluation of the water flow rate. The processing unit 5 compares this third value with the predetermined threshold (of 5% for example).

If this third value is greater than the predetermined threshold (in this case, greater than or equal), the processing unit 5 refuses the measurement: step E6. The processing unit 5 does not consider the first value and the second value. The processing unit 5 generates an alarm indicating that the measurement is abnormal: step E7. The processing unit 5 replaces the “present” evaluation of the water flow rate by the last valid evaluation: step E8.

In step E5, if the third value is less than the predetermined threshold (in this case, strictly), the processing unit 5 produces a consolidated evaluation Q3 according to the first value and the second value: step E9. The processing unit 5 uses the equation 3.

The method ends: step E10.

The invention has the following advantages.

The evaluation of the flow rate can be carried out by only using the amplitude differences of the upstream and downstream electrical signals. This way of evaluating the flow rate does not require using an ASIC, which can make it possible to reduce the cost of the ultrasonic measuring device 6 and therefore, of the meter 1.

The invention also makes it possible to improve the precision of the evaluation of the flow rate. By combining the information of the ΔV and of the DTOF, the method and the device of the invention make it possible to improve the precision of the ultrasonic meters, thus reducing the measuring errors caused by the alternation jumps and the weaknesses of traditional filtering modules.

The invention indeed makes it possible to verify if a flow rate measurement is correct or incorrect (for example, due to an alternation jump created by an air bubble, a temperature variation or an incorrectly configured trigger).

The invention makes it possible to filter an abnormal measuring point by combining the two pieces of information (amplitude difference, transit time difference).

The invention also makes it possible to protect the fluid distributor against loss of revenue. Contrary to traditional filtering modules, which can let high unbilled flow rates to pass, the method of the invention makes it possible to detect and to correct the measuring errors linked to the alternation jumps, thus ensuring a more precise and fair billing.

The approach proposed by the invention is simpler and easier to implement than the complex filtering modules traditionally used to resolve this problem. The measurement of the ultrasonic signals is possibly already taken to determine the transit time (in case the measurement uses both the transit time and the amplitude difference), and the use of these signals to calculate the upstream and downstream amplitude difference does not require additional measurements. Thus, this method fully exploits existing data, without adding complexity or costs to the instrumentation or to the processing of the data.

The method and the device of the invention can be applied to different types of ultrasonic and fluid meters, thus offering a versatile solution to improve the precision of the flow rate measurements.

By improving the precision of the ultrasonic meters, the invention allows savings to be made, by reducing the measuring errors and by improving the management of water resources.

Of course, the invention is not limited to the embodiment described, but comprises any variant entering into the field of the invention, such as defined by the claims.

The invention applies, of course, regardless of the positioning and the configuration of the upstream transducer and of the downstream transducer. The ultrasonic signals can be emitted with an orientation of any angle, with respect to a longitudinal axis of the conduit.

The predefined path between the transducers is not necessarily a direct path. The ultrasonic signals, emitted and received in the conduit by the transducers, could for example, be reflected by reflectors (for example by mirrors oriented at 45°).

The invention of course, does not only apply to a water meter, but to any meter of any fluid: gas, oil, etc.

A multivariate linear regression model has been used to evaluate the flow rate according to the DTOF and to the ΔV. The flow rate could be evaluated differently from these magnitudes and for example, by using a Kalman filter or a weighted average filter.

It has been indicated that the first value is representative of a difference between an amplitude of the upstream electrical signal and an amplitude of the downstream electrical signal. This is therefore, not necessarily the difference between the amplitude of the upstream electrical signal and the amplitude of the downstream electrical signal. This could, for example, be the difference between the amplitude of the downstream electrical signal and the amplitude of the upstream electrical signal.

This is also true for the second value, representative of a difference between the upstream transit time and the downstream transit time, and for the third value, representative of a difference or of a ratio between the first evaluation and the second evaluation.

1. A measuring method, implemented in a meter comprising a conduit, in which a fluid circulates and an ultrasonic measuring device comprising an upstream transducer and a downstream transducer, the measuring method comprising the steps of:
applying an excitation electrical signal to the terminals of the upstream transducer, so that it generates an upstream ultrasonic signal in the conduit and acquiring a downstream electrical signal produced by the downstream transducer when it receives the upstream ultrasonic signal;
applying the excitation electrical signal to the terminals of the downstream transducer, so that it generates a downstream ultrasonic signal in the conduit and acquiring an upstream electrical signal produced by the upstream transducer when it receives the downstream ultrasonic signal; and
evaluating a flow rate of the fluid in the conduit according to a first value representative of a difference between an amplitude of the upstream electrical signal and an amplitude of the downstream electrical signal.

2. The measuring method according to claim 1, further comprising the steps of:
measuring an upstream transit time of the upstream ultrasonic signal between the upstream transducer and the downstream transducer;
measuring a downstream transit time of the downstream ultrasonic signal between the downstream transducer and the upstream transducer; and
evaluating the flow rate of the fluid according to both the first value and of a second value, representative of a difference between the upstream transit time and the downstream transit time.

3. The measuring method according to claim 2, wherein the evaluation of the flow rate of the fluid is performed, from the first value and from the second value by using a multiple regression model.

4. The measuring method according to claim 2, further comprising the steps of:
measuring the first value;
producing a first evaluation of the flow rate of the fluid by using the first value;
measuring the second value;
producing a second evaluation of the flow rate of the fluid by using the second value;
evaluating a third value, representative of a difference or of a ratio between the first evaluation and the second evaluation;
if the third value is greater than a predetermined threshold, do not consider the first value and the second value; and
if the third value is less than the predetermined threshold, produce a consolidated evaluation of the flow rate of the fluid according to the first value and the second value.

5. The measuring method according to claim 4, wherein the third value is equal to: (Q2−Q1)/(Q2),
where Q1 is the first evaluation and Q2 is the second evaluation.

6. A fluid meter comprising a conduit in which the fluid circulates, an ultrasonic measuring device comprising an upstream transducer and a downstream transducer, and a processing unit, in which the measuring method according to claim 1 is implemented.

7. (canceled)

8. A non-transitory computer-readable recording medium on which a computer program comprising instructions which lead a processing unit of the meter to execute the steps of the measuring method according to claim 1 is recorded.
